(19) United States
(12) Patent Application Publication
(10) Pub. No.: US 2007/0086782 A1
(43) Pub. Date: Apr. 19, 2007

(54) Optical Rotating Data Transmission Device with Prism Coupler

(75) Inventors: Harry Schilling, Eichstaett (DE); Georg Lohr, Eichenau (DE); Thomas Tartler, Moorenweis (DE); Rainer Hutterer, Muenchen (DE)

Correspondence Address: DAFFER MCDANIEL LLP, P.O. BOX 684908, AUSTIN, TX, 78768, US

(73) Assignee: Schleifring und Apparatebau GmbH, Fuerstenfeldbruck (DE)

(21) Appl. No.: 11/379,282

(22) Filed: Apr. 19, 2006

(30) Foreign Application Priority Data
Apr. 19, 2005 (DE) 10 2005 018 093.0

(51) Int. Cl. G02B 6/42; H04B 10/12; G02B 6/26

(52) U.S. Cl. 398/141; 385/31

(57) ABSTRACT

A device for signal transmission between units that are movable along predetermined tracks comprises at least one light guide for guiding light, and a prism disposed to be movable along the light guide at a short distance from the light guide for coupling light into or out of the light guide.

### CONTINUING DATA

This application claims priority to German Application No. 10 2005 018 093.0 filed Apr. 19, 2005.

### BACKGROUND OF THE INVENTION

1. Field of the Invention

The invention relates to a data transmission system for optical transmission of data by means of light guides, in which a transmitter and/or receiver can be moved or differently positioned along a light guide.

Devices of this kind are utilized for example in a linear configuration in crane systems or other conveyor systems for transmitting data between a movable crane and a stationary control unit. Another field of application of these data transmission systems having a circular configuration is that of a transmission between parts that are rotatable relative to each other, such as for example in a computer tomograph between a rotor for supporting an X-ray tube and a detector, and a stationary evaluation circuit for processing and displaying image data.

2. Description of the Prior Art

The U.S. Pat. No. 4,962,986 describes a device in which, for coupling light into and out of light-guiding fibers, a coupling medium having a higher refractive index than the surroundings is put into direct contact with a fiber core. With this, a deflection of the light carried in the fiber into the coupling medium is effected.

In Tamir “Integrated Optics,” Springer Verlag, Berlin, 1979, page 87, another device for optical transmission is described. In this, a prism serving for coupling-out is positioned at a distance which is as small as possible above a fiber core. In order to achieve a reasonable coupling efficiency, the distance between the prism and the fiber core must be of the order of magnitude of the light wavelength.

In the present exposition reference is made to the term light guide as being a general term. This term relates to the preferred embodiment as a light waveguide, in particular a fiber, because light can be guided with little attenuation especially over long distances only with a light waveguide. Of course, the subject matter of the invention may be applied with equal effect also to all other kinds of light guides. Therefore no further distinction between these terms will be made in the present document.

Furthermore, in these expositions reference is made to the term “prism” as a coupling element, because this corresponds to the preferred embodiment of a coupling element. However, this is intended to cover also similarly acting coupling elements such as fibers or hemispheres having ground surface portions that make possible a coupling in a near field of the light guide.

### BRIEF SUMMARY OF THE INVENTION

The invention is based on the object of providing an optical data transmission system which no longer has the above-mentioned disadvantages and which, in particular, is suitable for non-contacting transmission at high data rates along a long path at speeds in the range of up to several m/s at comparatively low manufacturing costs.

In order to simplify the description, hereunder reference will be made to a transmission from a rotating part to a stationary part of a computer tomograph. Of course, a device in accordance with the invention may also be used in the reverse transmission direction. Similarly, a device in accordance with the invention may also be utilized in other applications for rotary transmission, and similarly for linear transmission between two units that are movable relative to each other.

A device in accordance with the invention for transmitting optical signals between at least two units that are movable relative to each other, in particular between the rotating parts of a computer tomograph comprising: a first unit that comprises a light guide disposed along a track of movement, a core of the light guide being only partially enclosed along its axis by a sheath; a second unit that comprises a coupler that is movable along the light guide for coupling optical signals into or out from the light guide; at least one optical transmitter (light source); and at least one optical receiver.

An optical path is provided for establishing a connection at least between an optical transmitter and an optical receiver. This passes through the light guide and the coupler.

The device in accordance with the invention furthermore comprises as a component part of the coupler at least one prism for coupling light in or out, the prism being guided at a small distance above a light guide, preferably an optical fiber, in order to couple light into or out of the light guide. Here a precise guiding of the prism is advantageously effected on a thin air film by making use of the Hydrodynamic Paradoxon, also known as the Bernoulli Effect. Thin films of this kind make possible a precise bearing action at distances within a range of a few micrometers. The mechanical stiffness of air films of this kind is very large, so that even changes in the abutment force, as arise for example with changes of height because of mechanical tolerances or mechanical accelerations, have an only small effect upon the thickness of the air film, and thus upon the distance of the prism to the light guide.

In order to make possible a coupling-in or coupling-out, the core of the light guide is only partially enclosed by a sheath along its axis. For this, at least the locations serving for coupling with the prism have no sheath. Thus, the light guide may be fabricated from the start, for example to be only partially sheathed. Similarly however, it is also possible subsequently to remove a portion of the sheath from a completely sheathed light guide. The is may be effected, for example, by grinding.

It is of particular advantage for the core to be designed so that it comprises a defined surface for coupling with the prism. Thus, a predetermined part of the surface of the core is provided for coupling with the prism.

### BRIEF DESCRIPTION OF THE DRAWINGS

In the following the invention will be described by way of example, without limitation of the general inventive concept, on examples of embodiment with reference to the drawings.

FIG. 1 schematically shows in a general form a device in accordance with the invention;

FIG. 2 shows a detail of a device in accordance with the invention comprising a light guide that is only partially sheathed;

FIG. 3 shows an example of an embodiment of the invention comprising two symmetrically disposed prisms for coupling-in signals in two directions;

FIG. 4 shows a sectional view of an example of an embodiment in accordance with the invention;

FIG. 5 shows an embodiment of the invention comprising a blower means;

FIG. 6 shows an embodiment of the invention comprising a suction means;

FIG. 7 shows an embodiment of the invention comprising a brush means;

FIG. 8 shows a device in accordance with the invention comprising a seal-air sealing means;

FIG. 9 shows a device in accordance with the invention comprising a labyrinth sealing means;

FIG. 10 shows another device in accordance with the invention comprising an excess pressure sealing means;

FIG. 11 shows a device in accordance with the invention comprising a brush sealing means;

FIG. 12 shows a device in accordance with the invention comprising a felt sealing means;

FIG. 13 shows a device in accordance with the invention comprising a sliding-ring sealing means;

FIG. 14 shows a device in accordance with the invention comprising a rotary-shaft sealing means;

FIG. 15 shows a device in accordance with the invention comprising a static sealing means;

FIG. 16 shows a device in accordance with the invention comprising a mechanical filter;

FIG. 17 shows a device in accordance with the invention comprising an electrostatic filter;

FIG. 18 shows an arrangement comprising a diaphragm sealing means;

FIG. 19 shows a device in accordance with the invention for repelling charged particles of dust an contamination;

FIG. 20 shows a device in accordance with the invention comprising a roller for taking-up charged particles of dust and contamination;

FIG. 21 shows a device in accordance with the invention comprising a surface coated with a combined micro/nanostructure; and

FIG. 22 shows an example of an arrangement comprising a controller for adapting a data rate.

### DETAILED DESCRIPTION OF THE INVENTION

The invention provides at least one variable optical attenuating member in an optical path for maintaining the optical attenuation of the path within a given range of tolerance, and advantageously to a predetermined constant value.

A control of the attenuation or light power is effected preferably by a control unit.

Another embodiment of the invention provides at least one optical transmitter of controllable power in an optical path for maintaining the optical attenuation of the optical path within a predetermined range of tolerance, and advantageously to a predetermined constant value.

In another advantageous embodiment at least one optical receiver is designed to be a converter of optical signals to electrical signals. Furthermore, means are provided for electrically controlling the electrical sensitivity or amplification. A control unit is provided for controlling the electrical sensitivity or amplification, or also (electrical) spectral properties so that the electrical signal amplitude or other electrical parameters such as signal to noise ratio, signal course, or eye diagram are within a predetermined range of tolerance.

At least one variable optical attenuating member may also be designed to be an optically active medium which changes its attenuation according to the intensity of the incident light. Alternative embodiments comprise an optical stop, as used for example with camera objective lenses, a neutral density wedge filter which is inserted into the path of the light rays according to the required attenuation, or a doubly refracting element designed to be an LCD, for example.

Embodiments of the control unit comprise a control performed in dependence upon the relative position of the first unit with respect to the second unit, a control unit that is incorporated by feedback into a regulation loop for regulating an output quantity, and also a control unit with a mechanical gearing.

Furthermore, in accordance with the invention a diagnostic unit may be assigned to at least one of the movable units. This diagnostic unit determines parameters of at least one optical path and/or other components or componentry on at least one of the movable units, and signals them to a user, or transmits them to a central control unit. In an advantageous manner, particularly critical parameters such as signal amplitude, signal to noise ratio, signal course, or eye diagram are determined.

Another device in accordance with the invention comprises a signal processing circuit for increasing the steepness of signal flanks of digital signals supplied by the data source, so that the reciprocal values of rise and fall times are each greater than the lower frequency limit of the entire transmission path. This includes also the frequency limits of the electrical components. As a result of the transmission of signals of this kind along a data path of limited bandwidth, narrow pulses arise at the locations of the signal flanks. These may now be detected by a suitable evaluation circuit, and recovered or reconstructed to form correct signals on the transmitter side. For recovery, a flip-flop, or even a comparator with hysteresis for example, may be employed. As a result of this embodiment in accordance with the invention, it now becomes possible to transmit even arbitrarily slow signals, i.e. pulse sequences with arbitrarily large intervals via optical data paths of limited bandwidths.

Another device in accordance with the invention provides a cleaning unit for removing dirt and/or dust particles from the light guide. It is the primary purpose of the cleaning unit to remove contamination from the light guide. Of course, contamination may also be removed from surrounding components such as a bearing assembly, in particular an air-bearing assembly.

In another embodiment of the invention, at least one cleaning unit is connected to at least one second unit, so that it moves together with the second unit along the light guide. Thus, the cleaning unit travels together with a movement of the second unit. Thereby a simple design of a supporting and driving structure may be achieved for the cleaning unit. It is particularly expedient for the cleaning unit to be guided along the direction of movement ahead of a light coupler, so that the light guide may be cleaned prior to a transmission. With embodiments using liquid cleaning means, it may be of particular advantage to guide the cleaning unit to follow behind a light coupler along the direction of movement, because then any cleaning fluid remaining on the light guide may dry. It would be of particular advantage to use a cleaning fluid having a refractive index ranging from the refractive index of the light coupler to the refractive index of the light guide. This may be an alcohol, for example.

Another embodiment of the invention provides a cleaning unit that is movable along a light guide independently from a second unit. With this embodiment, control of travel of the cleaning unit can be made independently from the movement of a light coupler. Thus, both may be moved at different speeds, in order to achieve, for example, a conforming of the speed to the amount of contaminating matter. Accordingly, a plurality of cleaning appliances may be provided to move along the light guide at fixed intervals, or also independently from each other. According to the design of the cleaning unit, the movement may be along the same track as that of a light coupler. With this, it is not possible for a cleaning unit to overtake a light coupler. Nevertheless, the local speed of a cleaning unit may be conformed. Thus, for example, it may be reduced at a particularly heavily contaminated location, and at least briefly increased following a cleaning of this location, in order to prevent a collision with a light coupler. Alternatively, a cleaning unit also may be designed so that it uses a different track than a light coupler. Here a cleaning unit of this kind may be moved completely independently from a light coupler. For this, the cleaning unit is preferably disposed laterally or above the track of the light coupler.

Another embodiment of the invention provides a sensor for detecting contamination. Furthermore, a control unit is optionally provided for adjusting the operating time and/or the intensity of cleaning of the cleaning unit in dependence upon the extent of contamination. Thus, for example, in the case of particularly heavy contamination, cleaning can be performed at a higher pressure, or at a higher temperature, or with a larger amount of cleaning fluid, whilst for example in the case of very small or no detectable contamination, the cleaning unit can be switched off. Thereby a low consumption of energy and also, as the case may be, a low consumption of cleaning agents may be achieved.

An advantageous embodiment of the invention provides a cleaning unit in the form of an appliance for blowing-away dust and particles of dirt. For this, preferably air in an air stream is blown onto the light guide with a nozzle. Of course, apart from air, other gases and even liquids are suitable. A source of pressurized air, or an air pump (gas generator, compressor etc.) is provided for supplying the nozzle with an air stream. The dust or dirt particles are whirled upwards from the surface of the light guide and carried away by the air stream. It is of particular advantage to dispose the nozzle so that the particles whirled upwards are blown away to a side the light guide. Air-guiding devices such as air-guiding plates may be provided to promote this effect. Advantageously, the air pump has a filter, so that only cleaned air is blown onto the light guide. Another improvement of the cleaning action may be achieved by generating vortices having a high locally confined streaming velocity at the surface of the light guide. For this, it may be of advantage to direct an air current counter to the direction of movement of the cleaning unit.

For applications in which an air bearing is provided for supporting a light coupler with respect to the light guide, an air stream for blowing away particles of dust and dirt can be generated from pressurized air ducts that are provided for conveying the air that is in any case required for the bearing.

In another advantageous embodiment of the invention, a cleaning unit comprises a suction appliance. A suction appliance of this kind is connected to a source of sub-atmospheric pressure such as an air pump. It has a suction opening through which air is sucked away from the surface of the light guide. This suction opening is preferably disposed so that it produces as high as possible a streaming speed at least within a narrow area above the surface of the light guide. This streaming speed should be dimensioned to be so high that a large proportion of dirt particles are swept up. In advantageous manner, a filter is also provided in the air stream for holding back the particles of dust and dirt, so that they are not discharged into the surrounding air. A suction appliance of this kind may be very advantageously combined with the above-described blowing-away appliance. In this case it may be sufficient for the appliance for blowing away to generate an air stream of a high speed. This suction appliance then need only remove the swirling particles, but requires no high streaming speed for this.

Another advantageous embodiment of the invention provides a brush unit for cleaning the surface of the light guide. This brush unit typically comprises a brush holder for accommodating one or more brushes. The brushes are disposed so that they slide along the surface of the light guide. The brushes may be configured like paintbrushes, but also may have the shape of a roller. Advantageously several brushes are disposed in succession along the direction of movement in order to achieve particularly thorough cleaning. Furthermore, brushes of different hardness may be combined with each other in order to remove various particle sizes of different contamination from the light guide. Here too, a combination of a brush unit with the previously described suction appliance and/or the previously described blowing-away appliance is of special advantage. Hereby a substantially stronger cleaning action can be achieved than with only one of these devices.

In another embodiment of the device in accordance with the invention, the first unit and the second unit are designed so that they jointly surround at least one light guide. An inner region is defined in the surrounded space containing the light guide. An outer region is present outside the entire arrangement. Gaps formed of necessity by the rotatable arrangement of the two units relative to each other extend between the inner region and the outer region. Furthermore, a device is provided for separating the inner region from the outer region. This device is configured so that an entry of dirt and/or dust particles from the outer region into the inner region is rendered difficult or prevented. It preferably operates in a hydrodynamic manner.

In an especially advantageous embodiment of the invention, this hydrodynamic device is supplied with air that has already been used for operating a hydrostatic or hydrodynamic bearing, in particular an air bearing.

In another advantageous embodiment of the invention, seal air is blown into the gaps and through at least one seal air nozzle. This seal air provides at least an air stream that passes from the inner region into the outer region, and renders difficult an entry of interfering particles. For an attainment of an optimal effect, the height of a gap should be within a range of 0.03 to 0.1 mm. Especially advantageous is a height of an order of magnitude of 0.6 mm. A pressure of the seal air of 0.2 to 0.5 bar at the place of ejection from the seal air nozzle has proved to be of advantage. For discharging the amounts of seal air passing to the inside, and the supplied air stream, a vent valve is advantageously provided. For an improved distribution of the seal air along the circumference of the arrangement, it is of advantage to provide additional annular grooves in the vicinity of at least one gap or. Similarly, it is of advantage to feed in the seal air at several positions, preferably along the circular circumference. It is of special advantage to use seal air to seal-off both gaps from an entry of dirt and dust.

Another advantageous embodiment of the invention provides at least one labyrinth sealing means in the vicinity of the gaps. To configure the labyrinth sealing means, the first unit and also the second unit comprise recessed portions, such as annular grooves, and raised portions, such as ribs intermeshing with the recessed portions, in the vicinity of the gaps. It is essential for the protrusions and recesses to intermesh with each other. This increases the path length between the outer region and the inner region. Furthermore, the flow resistance is increased. A design having sharp edges causes additional vortices that lead to contaminating matter being deposited within the labyrinth before it can penetrate into the inner space. Owing to the increase of the flow resistance, a smaller quantity of air is sufficient for supplying the inner region with seal air.

Another embodiment of the invention provides brushes between the inner region and the outer region in the vicinity of the gaps. This enables a relatively good sealing action to be achieved, particularly in combination with narrow gaps or labyrinths. This embodiment also permits protection of the inner region during non-operation and when no air is being supplied. Dust and contamination collected on the brushes can be blown away outwards by a higher air-pressure.

In another embodiment of the invention, a felt sealing means, for example in the form of a felt ring, is provided between the inner region and the outer region in the vicinity of the gap. This too results in an especially good sealing effect which is maintained also during non-operation and without air being supplied from the inner region. With an increased air pressure from the inner side, provision can be made for any possibly necessary lubricant not to enter into the inner region.

Another embodiment of the invention makes provision for using a sliding-ring sealing means. At least one sliding ring with a fitting counter-ring makes good sealing possible between the inner region and the outer region. In an advantageous manner, two sliding-ring sealing means are combined with each other so that they form a closed intermediate space between the inner region and the outer region. In an advantageous manner, this intermediate space can then be filled with a sealing medium, or a lubricant, or a cooling medium for the sliding-ring sealing means. This can be supplied through openings, and discharged through openings. Because an escape of air from the inner space is no longer possible owing to the sliding-ring sealing means, a vent valve is necessary for discharging the supplied air stream. An embodiment of this kind having sliding-ring sealing means needs substantially no servicing. Any abraded matter formed may be taken up by the lubricant and discharged. The inner region is protected from contamination even during non-operation and without a supply of air.

Another embodiment of the invention provides for the use of at least one rotary-shaft sealing means. At least one such rotary-shaft sealing means is provided in a gap between the inner region and the outer region. Advantageously, two such sealing means are provided in series, so that they define a closed intermediate space which, as already set out above, is filled with or can be supplied with a sealing medium, a lubricant, or a cooling medium. Here too, any abraded matter possibly formed can be carried away by these means. Similarly, here too the inner region is protected from contamination during non-operation and when no air is supplied.

In another advantageous embodiment of the invention, a light-transmitting cover is provided to be firmly attached to the first unit. Together with the first unit, this light-transmitting cover seals the light guide from the outer region. Furthermore, for optimal coupling with the light guide, at least one optical element is provided that allows free positioning of a light beam path through the light-transmitting cover. The light-transmitting cover may become contaminated in the same way as the unprotected light guide. However, the advantage of the light-transmitting cover is that it may be configured, for example, as a plane surface, and therefore to be easily cleaned. Furthermore, it is of advantage for the light beam passing freely through the light-transmitting cover to be expanded relative to the beam guided in the light guide. With this, a transmission remains possible even with single dust and dirt particles deposited on the surface. Furthermore, the optical arrangement for transmission through the light-transmitting cover can be so designed that the light-transmitting cover is disposed outside the focal point, and preferably in a parallel light beam.

In another embodiment of the invention, a dust filter is provided between the first unit and the second unit in the vicinity of at least one gap. The filter tightly seals the gap at least against dust and dirt particles, but allows air to escape from the inside. This embodiment too is sealed from dust and dirt particles during non-operation and when no air is supplied. A loaded filter may be easily cleaned from the inside by means of an increased air pressure. The filter preferably consists of a woven fabric such as gauze, but may also be of filter paper. An optimum additional filter has a large capacity and can also filter off coarse contamination.

In another advantageous embodiment of the invention, an additional filter is designed as an electrostatic filter.

Another embodiment of the invention provides for a sealing diaphragm to be disposed on one of the two units in front of a hollow space, and adapted to be moved by impaction of the hollow space with vacuum or pressurized air. By impaction with pressurized air, the sealing diaphragm can be positioned close to, or urged against, a confronting surface that is preferably assigned to the other unit. By impaction with vacuum, the air is at least partially sucked out of, and the diaphragm drawn into, the hollow space, so that the distance from the opposite surface is enlarged and the sealing means thereby opened. In an advantageous manner, the diaphragm is dimensioned so that in a rest condition it lightly abuts against the opposite surface to achieve a certain minimum sealing in this rest condition. Furthermore, in an advantageous manner a seal is mounted on the opposite surface in order to form a defined seat surface to the sealing diaphragm.

In another arrangement in accordance with the invention, at least one sliding body is provided to serve for accommodating a second light coupler. Furthermore, this sliding body is provided with a magnetic bearing means. The magnetic bearing means serves for precise guidance along the light guide. It may be designed to be static or also dynamic. Thus, optionally permanent magnets or also electromagnets may be provided to generate the magnetic fields. Furthermore, it is of advantage to provide an additional, preferably electronically controlled position regulating means.

For reasons of clear illustration, in the previously described embodiments reference was made to air as being representative of any desired gases. Of course, a system according to the invention may be put into practice to operate with any desired other gases, preferably nitrogen.

It is of particular advantage for several of the previously described embodiments to be combined with each other in order to achieve a particularly efficient sealing of the system.

A device in accordance with the invention comprises a device for electrostatic filtering and/or removing abraded particles. A device of this kind is furthermore capable of removing also foreign dust and dirt particles. Similarly, an electrostatic device according to the invention can be used to remove the dust from the sliding contact assembly, in order to avoid a deterioration of the insulation.

In an especially advantageous embodiment of the invention, the electrostatic device is designed to be an electrostatic air filter. This comprises at least one electrode that can be subjected to a high voltage. Because very many of the abraded particles are already emitted into the surrounding air where they are distributed in the form of a fine dust, the electrostatic filter arrangement according to the invention is used to filter away the particles that are present in the air and are charged.

Furthermore, in advantageous manner at least one corona electrode is provided that can be subjected to a high voltage and performs a charging of not yet charged particles in the air. This can also be effected by an ionization of the air. The corona electrode is preferably formed to be a thin wire, in order to achieve as high as possible an electric field strength in the vicinity of the electrode.

Another embodiment of the invention makes provision for at least one means for generating an air stream to be present. A means of this kind may be of an active kind, such as a blower or a ventilator. Similarly, this means may also be a means for directing air, such as air guiding plates or air ducts. Of course, both kinds of means may be combined. In many cases of application, simple means for directing air, such as air ducts, are sufficient, because the movement of the second unit relative to the first unit already gives rise to an adequate air stream. It need only be deflected in a correct direction, so that it will preferably first pass the corona electrode and then be guided past the electrode of large area. It is specially expedient to dispose a filter arrangement of this kind together with associated means for controlling the stream ahead of the optical components, so that they receive air that has already been cleaned.

According to the invention at least one blower can be provided for generating an air stream across the contact arrangement, or the light guide, or a light coupler. With this, the removal of abraded matter away from the contact zone or its surroundings may be further ensured, and the action of the electrode at a distance supported and/or enhanced. The abraded matter is thereby removed in a desired direction by the air stream.

It is of special advantage to combine means for electrostatic air filtering with other, preferably mechanical filters, for example mesh filters or paper filters, in order to achieve a particularly high filtering action.

Another embodiment in accordance with the invention provides for at least one means for taking-up dust and dirt particles to be disposed close to the surface of one of the two units. This means is subjected to high voltage, so that charged dust and dirt particles are attracted. Thus, a cleaning of the air streaming through the system is not primarily performed, but rather than this, charged particles are withdrawn from a surface.

Furthermore, it is of advantage for this means to be designed as a rotatable body, preferably a roller. With this, during a movement across the surface of the first or second unit, a clean area of the rotatable body can always be brought into the vicinity of the first or second unit. At the same time, the surface of the rotatable body can be cleaned in a continuous operation. Similarly, the surface of the rotatable body can be recharged with electrical charges in a continuous operation.

In another advantageous embodiment of the invention, at least one of the electrodes consists of a material having a surface on which the abraded particles are highly adherent. Thereby the particles, once attracted thereto, are permanently bound to the electrode, even during a failure of the electrode voltage. Materials of this kind may be, for example, rubber-like materials to which carbon dust adheres well, or other materials such as those used in the form of adhesive tapes.

In another embodiment of the invention at least one electrode is designed to be an exchangeable one-way electrode.

In another advantageous embodiment of the invention, at least one blower is additionally provided to convey the contaminated air from the contact position to the electrodes. Hereby the abraded material is directed by the air stream towards the electrodes for removal.

As an alternative to this, a part of the filter arrangement can be designed to be an exchangeable one-way component group. Using one-way electrodes or one-way component groups, a rapid and simple exchange of contaminated parts is possible. Similarly, an additional device for cleaning the collecting device or the electrodes may be present, so that a uniform and optimal disposal operation by the at least one electrode may be ensured.

For cleaning the arrangement, according to the invention a removal of deposits from the collecting device may be effected by a device generating mechanical vibrations. Thus, the cleaning operation may be performed automatically and continuously, for example without any manual cleaning of components. The abraded particles may be, for example, advantageously collected in a container into which they drop owing to the vibrations. This container may be emptied at large intervals of time. Thus, an elaborate and inconvenient cleaning operation performed on the collecting device itself, or the electrode, or a filter, may be dispensed with.

An advantageous arrangement is obtained when the device for electrostatic removal of dirt and dust particles is mounted to be as close as possible to the sliding contact arrangement at which they originate.

Another embodiment of a device in accordance with the invention comprises an especially designed surface coating that is applied preferably at locations of the first unit and/or the second unit. This coating has a double structure with a coarse structure (microstructure) of a size between 1 μm and 100 μm, preferably between 10 μm and 50 μm, and an overlying fine structure (nanostructure) of a size of 10 nm to 5 nm, preferably of 20 nm to 1 μm. The microstructure is preferably formed by particles fixed on the surface and having a size of less than 50 μm. Their sizes are preferred to be less than 35 μm, and most preferred to be less than 20 μm. The particles preferably have a rugged structure with raised portions and recessed portions of sizes in a nanometer range. These have a height that is preferred to be 20 nm to 500 nm, and especially preferred to be 50 nm to 200 nm. The distance between raised portions or recessed portions, formed for example by hollow spaces, pores, furrows, peaks and/or spikes, is preferred to be less than 500 μm, and specially preferred to be less than 200 μm. The coated surfaces have the structure-forming particles on the surface at preferred distances of 0 to 10 particle diameters, particularly at distances of 0 to 3 particle diameters, and most preferred distances of one to two particle diameters.

Coatings of this kind were originally conceived to be so-called self-cleaning surfaces from which drops of water run off and take with them accumulated dirt. However, during tests the surprising effect was observed that surfaces of this kind already substantially prevent an accumulation of finest dirt particles as formed for example by abrasion from brushes. Thus, “washing” of the surface with water drops that run off is not necessary, as in the case of a lotus effect. This precautionary effect is further improved by currents of air or gas. Particularly in the case of systems such as sliding contact devices in which during operation the components move with respect to each other, an air current of this kind is caused already by the movement. The effect is further enhanced by stronger air currents that arise for example during enforced venting.

With this invention, an accumulation of abrasion from brushes and other contamination can be avoided or at least reduced.

The invention generally relates to the design of a surface. A surface in accordance with the invention may be achieved preferably by coating, or also by a different configuration of the surface structure, as may be obtained for example by etching. For reasons of overall clarity, reference will be made hereunder mainly to the term “coating” only, but this is intended to include also other designs of surface structure.

In another advantageous embodiment of the invention, the coating or surface structure is designed to have anti-static properties, or has a thin film with anti-static properties applied thereon. Thus, dust is frequently attracted to an increased extent by static charging of the surface. This additional attractive effect may now be reduced by an anti-static design of the surface, so that for example the surface has an at least small conductivity.

In an especially advantageous embodiment of the invention the coating is applied preferably around optical components, and preferably in the form of a surface that is itself closed or continuous. With this, the coating surrounds optical components. These are located similarly to islands within a surface enclosed by the coating.

In another embodiment of the invention, further surfaces without any coating are provided between the surfaces that have a coating, or the continuity of the coating is interrupted by surfaces without any coating. These surfaces are preferably disposed so that they do not form any connecting paths between conducting parts of different potentials. Abrasion from brushes cannot become attached to the coated surfaces. Rather than this, it will travel along the coated surfaces until it encounters an uncoated surface on which it can be deposited. The uncoated regions at the edge of the coated surfaces thus serve as collecting surfaces for abrasion from brushes. With this, the abrasion from brushes can be confined to predetermined regions within which it does not impair the insulation. In addition, the collecting surfaces may be located so that they are easily accessible for cleaning. If, for example, regions of difficult access are provided with the coating, then they need no longer be cleaned for servicing. These surfaces may also be designed to be collecting containers of large capacity. The abrasion from brushes can be removed from the easily accessible uncoated surfaces, for example by means of a vacuum cleaner.

Another embodiment of the invention consists of the interruptions of continuity of the coated surfaces having at least a microcrystalline microstructure, the surface structure of which has raised portions and recessed portions in a size range of 5 μm to 100 μm at a spacing from each other in a range of 5 μm to 200 μm.

In another embodiment of a device in accordance with the invention, an absorber, preferably a controllable absorber, is provided at least at one location in the optical path of the light guide. Optionally, the preferably controllable absorber may be contained within the light guide. But it may also be incorporated in the optical path of the light guided through the light guide, so that the light is incident on the absorber at predetermined or settable positions. A preferably controllable absorber of this kind effects an attenuation of the light passing through it. With an attenuation that is settable in accordance with the invention, the signal amplitude or the amplitude of undesired signals may be specifically set. Thus, a particularly simple adaptation to different attenuations of the light guide, caused by fabrication tolerances for example, is possible. Basically, with a controllable absorber of this kind, the power of the light coupled out at the second light coupler is also settable.

In another advantageous embodiment of the invention, the light guide is divided into at least two segments, means being provided for an optical isolation of the segments from each other. An optical isolation may be effected, for example, by absorbing materials between the segments, by deflection of light between the segments, such as by means of mirrors, gratings, or scattering materials, or also by a separation of the directions of the optical signals.

In addition, the lengths of the segments, and also the directions of propagation of the light in the segments, are preferably dimensioned so that the modulation signal has only minor differences of transit time or phase at the boundaries between any two segments in which the same signal is being transmitted. These differences are required to be small in comparison with a period length of the modulation signal. Thus, the entire signal transit time of the signal from the optical transmitter to the optical receiver will also have only minor differences at the boundaries of the segments. A wideband signal transmission may be achieved thereby. In order for an interference-free transmission to be possible within the entire rotation range of 360 degrees, the above-mentioned conditions must apply to all connecting positions between each of two adjacent segments.

Of course, with a device in accordance with the invention a plurality of signals may also the transmitted simultaneously. It is only necessary for the previously mentioned condition to be satisfied for each of these individual signals. The relationship between different signals may be as desired.

The insulation (absorber) between a plurality of segments may also be designed to be a poorly reflecting coupling-out position. At this, for example, a monitoring receiver can be mounted for monitoring the transmitted signal amplitude. Similarly, this insulation may be implemented to be dependent on wavelength. Preferably it is designed to be a thin film. If the light guide is executed to be a mirror-finished trench, then a coupling-out position is preferably executed to be a tangential bore.

In another advantageous embodiment of the invention, groups are provided, each consisting of two adjacent light guides having the same length and an opposite direction of propagation of the light. In the simplest case, the entire arrangement, as described above, possesses only one single group of this kind. Similarly, however, a plurality of such groups can be disposed along the circular circumference. They also may each be of different segment lengths, as long as both segments of a group have the same length. Thus, for example, for reasons of design different segment lengths may be provided to simplify the mounting. A division into a plurality of segments also offers the advantage that data may be transmitted in each segment independently from the adjacent segments. For this, a number of couplers corresponding to the number of channels, in addition to associated optical receivers, must be provided. This means that a correspondingly higher total data rate can be achieved. If, for example, an arrangement of four groups is provided along the entire circular circumference, then the total data rate may be multiplied by means of a simultaneous transmission of four signals. In an advantageous manner, the assignment of the channels is effected by means of a multiplexer, and the control by means of a position transmitter.

For this, advantageously the light guide is divided into an even number of segments. Owing to the even number of segments, the arrangement may be implemented very easily because of the symmetry. A design of particularly low-cost is obtained with two segments. In order to achieve a constant transit time at the segment boundaries with two segments, these must be of the same length and have opposite directions of propagation of the light. In the case of two segments, the preferably controllable absorber is disposed at a position of 180 degrees opposite to the coupling-in position. In the case of light being coupled into the first unit, this means that the preferably controllable absorber is disposed to be displaced through 180 degrees about the axis of rotation of the two units.

Instead of disposing the absorber at a discrete position, it could also be distributed in the light guide at various locations. Similarly, a light guide having a predetermined attenuation could be provided. Here the attenuation should be at least 6 dB per rotation, in order that repeatedly circulating signals become adequately attenuated. As a result of using an attenuated light guide, it even may be possible to dispense with a preferably controllable absorber.

For coupling-in light through the second unit (and transmission from there into the first unit), a controllable absorber is used which is adapted to follow the rotational motion of the second unit relative to a mirror trench. This controllable absorber also may be supported at a desired site, preferably opposite to the coupling-in site of the corresponding second light coupler, for example, with a bearing regulation means, or a hydrostatic or hydrodynamic bearing means, as is described for the second light coupler.

In the presumably most frequent case of a division of the light guide into two circular segments of equal length, the controllable absorber is advantageously disposed to be as exactly as possible opposite to the first light coupler. At the location of the absorber, light enters from both directions of the circular segments. The transition point at which the light intensity from both directions is equal must at the same time be the point at which the phase shift between the signals of both directions is equal to zero, or at least smaller than the duration of one data bit. If now an absorber having a constant absorption factor is employed, then the transition point will correspond to the mid-point of the absorber only when the latter is fed with light of the same intensities from both directions. If the intensity from a first direction is greater than from the other direction, then the transition point will shift toward the other direction. Different light intensities in both directions may result from, for example, fluctuations or fabrication tolerances at the first light coupler, but also from a transmission loss of the light guide. In order to avoid too strong a shift of the transition point, and of transmission errors possibly resulting from this, an adjustment of the absorbers becomes necessary. This can be avoided by means of a dynamic adjustment of the controllable absorber. Thus, optionally the absorptive power, or also the position of the absorber, can be conformed. Advantageously, a higher absorptive power thus can be set in the direction of the signal having the higher light intensity, or the absorber can be displaced by control in this direction. In advantageous manner a regulating system is provided for this, having for example at least one light sensor for determining the intensities of the light carried in the light guide, or a sensor for determining the transition point. Information of this kind for determining the transition point can be obtained, for example, from the intensity of optical signals, but also from time information or jitter information of a received signal.

Another advantageous embodiment provides for the controllable absorber to be disposed along the entire circumference of the light guide, and for only correspondingly needed positions to be activated for absorption by control. The not activated regions serve for guiding light without absorption. Here the concept of activation means only a setting of an absorption. Of course, a controllable absorber having an opposite effect, which absorbs without activation and does not absorb upon activation, is also usable.

Another advantageous embodiment of the invention provides a plurality of controllable absorbers which are of variable position, and/or can be activated or deactivated at given positions. With these controllable absorbers the light guide is divided into a plurality of segments. These segments can then be employed for a simultaneous transmission of different signals.

Another advantageous embodiment of the invention provides a device for controlling a controllable absorber so that the attenuation of an optical signal between a first light coupler and a second light coupler is approximately constant.

It is of particular advantage for a controllable absorber to have two segments adapted to be alternately actuated. With these two absorber segments, the run of the light guide can now be divided into a total of three parts. During passage along the light guide, starting from a position of the second light coupler at the first light coupler, the nearer absorber segment is set to minimum absorption, and the remoter absorber segment to maximum absorption. Thus, light is exclusively transmitted in the first direction between the first light coupler and the second light coupler. Because the signal of the second direction cannot be received by the second light coupler, no phase compensation is necessary. As soon as the second light coupler has passed the first absorber segment set to minimum absorption, the absorber segments are switched over. This means that now the first absorber segment is switched to maximum absorption, and the second absorber segment is switched to minimum absorption. Thus the second light coupler will now receive the optical signal from the second direction In order to achieve an interference-free transition between the receipt of the first direction and the second direction, the signals from both directions are matched to each other by a delay in accordance with the invention. When the second light coupler has passed the second absorber segment, then it may be moved along the remainder of the path even without any transit time compensation. It is of particular advantage to set back the previously introduced delay gradually to zero along the remainder of the path.

It is of particular advantage for the distance between the two absorber segments to be kept as short as possible. Furthermore, in this case it is of advantage to dispose the center between the absorber segments to be opposite to the position of the first light coupler. Similarly, it is possible to subdivide the absorber and/or the light guide into a plurality of segments.

A controllable absorber of this kind is advantageously controlled by a regulation circuit so that a constant light intensity is achieved independently of the transmission direction of the light, optionally at a second light coupler or a first light coupler. A regulation of this kind is particularly advantageous for reducing the dynamic ratio at the input of the optical receiver, or for safeguarding the latter from optical over-saturation.

Furthermore, in advantageous manner at least one preferably controllable absorber is designed to be wavelength-selective. Its spectral properties and preferably its absorption wavelength can be set.

Preferably a plurality of preferably controllable absorbers are designed to be wavelength-selective and are disposed at both locations according to the segment boundaries for a respective wavelength. This embodiment permits of, for example, wavelength-dependent different segmentations, or different arrangements of the segment boundaries, as necessary with an arrangement of the light couplers at different positions.

Furthermore, it is of advantage for the preferably controllable absorber to be designed to be polarization-selective.

In another advantageous embodiment of the invention the preferably controllable absorber comprises reversible scattering centers, the configuration of which can be controlled by a signal or a supply of energy.

Another advantageous embodiment of the invention consists in a medium being present for reversibly configuring scattering centers, certain physical properties of which change when a signal is applied or energy is supplied. Physical properties of this kind are, for example, the refractive index, the transmission, or also the volume. Here the fundamental effects may be, for example, the photorefractive effect, the effect of thermal non-linearity, the Theological effect, and others.

Another embodiment of the invention provides for the preferably controllable absorber to comprise at least one liquid crystal element.

Furthermore, it is of advantage for the preferably controllable absorber to comprise photonic crystals.

Another embodiment of the invention provides for the controllable absorber to comprise a controllable deflecting element for deflecting a settable proportion of the light carried in the light guide out of the light guide, and/or onto an absorber.

Another embodiment of the invention provides for the preferably controllable absorber to comprise a multi-layered system capable of interference.

In another advantageous embodiment, the controllable absorber comprises an optical grating.

Another advantageous embodiment of the invention consists in the controllable absorber being adapted to be inserted into the light path with an optical switch.

Another advantageous embodiment of the invention provides for at least one controllable absorber being adapted to be mechanically controllable. The control is effected preferably by means of an electromotive, electromagnetic, piezoelectric, or also pneumatic actuating element.

Furthermore, it is of advantage for at least one absorber to comprise a mechanical element that can be inserted into the path of rays of the light guide. A mechanical element of this kind may be a simple rod, for example. A rod of this kind may now be inserted into or retracted from the path of rays as required, for example by means of an electromagnet or an electric motor. Use of an electric motor also offers the possibility of controlling the depth of insertion, and with it the attenuation. Similarly, the mechanical element could also be held urged into the trench by a spring, so that it will be urged out of the light guide by a passing second unit or a second light coupler in order to open a passage.

In another advantageous embodiment, at least one absorber is suited to receive the optical signals at the same time. Thus, for example, it may be an optical receiver having a high absorbing power. This can now be employed for an evaluation or a monitoring of the signals. In this, for example, signal contents, signal quality, or also the amplitude can be checked.

In another advantageous embodiment of the invention, at least one second light coupler is provided for coupling light out of a light guide and guiding it to an absorber. In this embodiment, the absorber is not directly located in the path of the light guide. Rather than this, its site may be altered by the second light coupler. With this, an exact positioning, for example opposite to the first light coupler, is possible. Furthermore, adjustments of the coupling properties, or the attenuation, are possible by adapting the position of the second light coupler with respect to the light guide.

A device according to the invention comprises at least one light coupler that is adapted for directionally selective tapping of the optical signals from a light guide. This directionally selective tapping makes it possible to distinguish the direction from which the light carried in the light guide comes, and correspondingly to treat the light selectively. Furthermore, a device is provided for switching between the two directions of the light. A switch-over occurs at a time at which the transit time difference of the light in the light guide between the point of feeding-in by a first light coupler, and the actual position of a second light coupler, is smaller than 1 bit of the modulation signal of the light carried in the light guide. In a symmetrical configuration of the light guide, this position is opposite to the position of a first light coupler.

In another embodiment of the invention a controller is provided for optionally controlling at least one controllable absorber, an optical transmitter, a distance between a coupler and a light guide, or another optical component in the optical path in such manner that the optical or electrical signal amplitude at a coupler or preferably at an optical receiver is maintained at a constant value.

Another arrangement in accordance with the invention comprises at least one timing recovery circuit. Timing recovery circuits of this kind are also known by the term CDR (Clock and Data Recovery Circuit). With these it is possible to regenerate both the timing and also the data of a serial data stream. Timing recovery circuits of this kind are applied particularly expediently when associated with an optical transmitter and/or an optical receiver. Thus, integrated optical transmitters and receivers, and also combined transmitters/receivers (transceivers) with incorporated timing recovery circuits are already available on the market. Of course, timing recovery circuits of this kind can also be used at other locations of the transmission path. Thus, they may be already incorporated in the additional optical and/or electrical transmission paths connected upstream or downstream of the optical path. For example, if an optical data path for transmitting the data of a data source such as an X-ray detector, for example, to an optical receiver, is connected upstream of the optical path of the invention, then it would already be possible to incorporate a timing recovery circuit into this optical data path, so that the optical transmitter will be controlled by a good quality signal, and the transmission characteristics of the upstream optical data path are eliminated. Numerous embodiments of timing recovery circuits as used according to the present invention are known. In the simplest embodiments PLL's are used for resynchronization of a data stream. However, basically it is also possible to decode a data stream and to code it anew or to recode it.

In another arrangement according to the invention, a data source for generating a serial data stream, such as a parallel/serial converter according to prior art, is assigned to the first unit. This supplies the optical transmitter with electrical data signals. Furthermore, the signals of the optical receiver are passed to a data sink for processing of the signals.

Now according to the invention, a control unit is provided for selectively controlling the data source or an optical transmitter to issue a predetermined data rate or package size in accordance with a desired value. Optionally also, the controller may be disposed between the data source and the optical transmitter, and designed in such manner that it by itself formats and converts the data, data rate, or package size issued by the data source, in accordance with a desired value. Thus the issuing of the data can be adapted to the currently prevailing properties of a data path.

The essential feature of the control unit is its adapting of the coding of any digital signal to the transmission characteristics of the optical data path between the optical transmitter and the optical receiver.

By means of a device according to the invention, a substantially better quality of signal transmission can be achieved than in prior art.

Optionally a decoding means for converting the data rate or package size to the data rate or package size issued by the data source can be inserted in the second unit between the optical receiver and the data sink.

By means of this decoding means, an encoding made at the first unit is cancelled, so that the signals passed to the data sink correspond to the data stream of the data source. Of course, the decoding means may also be disposed in the receiver. Thus, an encoding for an optimum transfer of the data along the data path becomes completely transparent for the data source or data sink.

Particularly with units traveling relative to each other, the actual data rate to be transmitted frequently varies with time or position. Parameters of influence are, for example, the distance between the two units traveling relative to each other, the coupling between these units, or also external interference effects. With the aid of the encoding means, the data rate is continuously conformed. If, for example, at a particular point in time or at a particular position a transmission is possible only at a relatively low data rate, or not at all, the data of the data sources are intermediately stored in memory means. Now if the possible data rate of the data path is again increased owing to a passing of time or a change of position, then the intermediately stored information can be transmitted. The decoding means is designed in accordance with this, and also has means for storing data in the case of a high data rate from the encoding means, and therefore can ensure a continuous data stream to the data sink. For optimum control, optional means can be provided for measuring the transmission characteristics.

In most cases, generic transmission systems are provided with a transmission path which is closed along the track of the travel of the two units. A closed transmission path is present when the optical waveguide is in engagement with the coupling element, so that data can be transmitted. As an alternative to this, the transmission path may also be segmented, i.e. consist of several parts. In an extreme case the transmission path could consist of one single segment which is provided at a particular position. In this case, control is performed by the controller in such manner that transmission takes place exclusively at the positions where segments of the transmission path are available.

In another embodiment of the invention, the controller is designed to have means for storing data. Hereby it becomes possible to conform the data rate or segmentation to different package sizes without loss of data.

In another advantageous embodiment of the invention, a desired-value setting-means is provided for setting the desired value and optionally adapting the setting of the desired value dynamically during operation of the device according to the characteristics of the transmission path, such as, for example, the transmission quality, bit error rate, and signal-to-noise ratio, or simply on the basis of the position of the two traveling units relative to each other, or of time.

In another advantageous embodiment of the invention the encoding means has additional memory means as well as means for adapting the data rate of the serial data stream to be transmitted. Thus, the data rate can be conformed in accordance with the actual transmission characteristics of the transmission path between transmitter and receiver.

In another advantageous embodiment of the invention, the controller has additional means for storing the data. Furthermore, an auxiliary communication channel is provided between an evaluation circuit additionally disposed between the optical receiver and the data sink, and the controller, for incorrect data to be signaled by the evaluation circuit to the controller. Now, if the evaluation circuit detects incorrectly transmitted data, it signals this to the controller which thereupon reissues the data. Such mechanisms are basically known for signal transmission at higher levels. Thus, in these cases a communication takes place between a first computer which is connected to the data sources, and a second computer which is connected to the data sink. For this, the communication and the repeating of the data transmission requires additional computing capacity. Because of the integration at a low level of data transmission, the repetition of the transmission takes place independently from the transmission protocol and independently from additional operations of the communicating computers. Thus, the device according to the invention can be operated independently from the computer system connected thereto. At the same time it ensures a maximum flexibility and reliability of transmission at minimum additional load on the connected computers.

In another advantageous development of the invention, at least one micro controller is provided for control or diagnosis of the device. The micro controller optionally has a memory for storing particular events such as errors, or also an exceeding of limiting values. Advantageously such a micro controller has a web server, so that it can be operated locally by means of a conventional personal computer or an internet terminal, or via the internet. Furthermore, optionally a display of certain operating conditions or operating parameters is provided. Thus, for example, transmission errors, signal-to-noise difference, bit error rate or the exceeding of certain limiting values can be displayed. Optionally, the entire control may be newly configured using software. Thus, for example, memory contents, data tables or even program codes may be newly loaded as required.

In a further advantageous development, the device is designed to be self-learning or adaptive. This means that it dynamically adapts to the operating conditions, in particular during travel. This can be achieved, for example, by determining certain operating parameters such as bit error rate, signal amplitude etc., and subsequently setting the controller or the evaluation circuit or the filters. Here it is therefore particularly advantageous to use a fuzzy controller. Thus, for example, the redundancy or the data rate can be set as a function of the transmission errors. This means that for a large number of transmission errors, for example a higher redundancy is provided. Especially for rotary movements, in particular at constant speed, it is of advantage to store the transmission function in terms of a rotation and, in correspondence therewith, to perform the setting of the controller or the evaluation circuit or the filters in dependence upon time or the position. This, of course, is possible also for linear movements inasmuch as information is available concerning the position.

In a device in accordance with the invention, an optical transmitter is designed and connected to the light guide so that in each case it couples light into and out of the light guide in a first direction and in an opposite second direction, respectively.

Furthermore, a controller is provided for causing a time-shift of the signals between the first direction and the second direction. Each of these shifts is sufficiently large for the transit time differences of the signals between the first direction and the second direction to be compensated.

In an especially advantageous embodiment of the invention the controller comprises at least one optical time-lag or delay element. A time-lag element of this kind may be, for example, a thermo-optical phase-shifter, a piezo phase-shifter, a liquid crystal phase-shifter, a transit time line, a slow-light-element, photonic crystals, or a delay element with mode-selective coupling-in or -out.

In another advantageous embodiment of the invention, the controller comprises at least one electrical or electronic time-lag or delay element. A time-lag element of this kind may be, for example, a transit-time line, a phase-shifter, or a memory, preferably a digital memory. In another advantageous embodiment of the invention the controller may comprise separate electrical circuits for generating a serial data stream (serializer) and/or for decoding or converting a serial data stream (deserializer) for the first direction and the second direction, respectively. With this, the data streams of the first direction, and those of the second direction may be generated or decoded independently from each other. The separated serializer or deserializer are now supplied with clock pulses that are phase- or frequency shifted with respect to each other. Here the frequency or phase shift is dimensioned so that the transit times of the signals in the light guide are compensated. The compensation of transit times is thus effected in dependence upon location, corresponding to the position of the second unit relative to that of the first unit.

If a device, in accordance with the invention, of this kind is employed for example in a computer tomograph rotating at constant speed, a frequency shift corresponding to the rotary movement is obtained as a result of the Doppler Effect. For compensation, the serializer or deserializer for the direction along which the two units move away from each other is operated at a higher frequency, whilst the serializer or deserializer for the opposite direction is operated at a correspondingly lower frequency.

Because of the different operating frequencies, different numbers of bits are transmitted in the course of one revolution. This difference is only small and may be eliminated on one side by a repeated emission, and on the other side by deleting repeatedly transmitted bits. For a device for rotary data transmission having a circumference of 3 m this difference amounts to about 10 bits.

Another embodiment of the invention provides at least one absorber. An absorber of this kind is preferably disposed at a site which is opposite to that of the optical transmitter when referred to a rotation axis. Thereby the light guide is divided into preferably two segments of preferably equal size. Because of the phase shift in accordance with the invention, an absorber need no longer be point shaped. Rather than this, it may be disposed with its length extending above and along a portion of the light guide. Now it is the substantial purpose of the absorber to ensure that an optical signal that has already traveled around the circumference of the light guide does not lead to an impairment of a newly supplied signal.

Another advantageous embodiment of the invention provides for the light guide itself to be attenuating. This attenuation of the intensity of the radiation should be in a range of more than 6 dB along the length of the entire light guide. Advantageously the attenuation is greater than 12 dB, and it is especially advantageous for an attenuation of more than 20 dB to be provided. For example, within the range of the first direction, an especially strong attenuation of the signal from the second direction results from the attenuation by the light guide itself. Similarly, the signal from the first direction is especially strongly attenuated within the range of the second direction. With this, an especially simple kind of time-lag becomes possible. This will be explained on an example of a rotation of the second light coupler, starting from the range of the first direction into the range of the second direction. Let the second light coupler be within the range of the first direction and closely behind the first light coupler. For example, the first direction signal can be emitted without delay, whilst the second direction signal is emitted with large delay. With progressive movement of the second light coupler away from the first light coupler, the time-lag of the second direction signal becomes reduced. In fact, only the first direction signal is received in the vicinity of the first light coupler, whilst the amplitude of the second direction signal is still too low. A superposition of the two signals can be received only at a more distant range. In a position opposite to that of the first light coupler the intensities of both directions are equal. When this point is exceeded, the intensity of the second direction signal is higher than that from the first direction. Finally, with further movement of the second light coupler, the intensity of the light from the first direction is reduced until the second direction signal is no longer affected. Now the time lag of the second direction signal can be reset, without difficulty and without regard of the first direction signal, to the maximum value that is needed after the second light coupler has passed the first light coupler.

It is of special advantage for the attenuation of the light guide increases with increase of the distance from the optical transmitter. The maximum of the attenuation is advantageously at the site opposite to the light coupler. With this embodiment an especially good transmission is possible in the vicinity of the first light coupler owing to the low attenuation. This may be used, for example, with an own coding or modulation for transmission at a higher data rate. If now the second light coupler enters into a region remote from the first light coupler, then the attenuation strongly increases. Within this range, the transmission quality or the maximum achievable transmission rate therefore decreases. If now the increase of attenuation is limited to a narrow region, then the range of impaired transmission is also kept within narrow limits.

A more uniform transmission characteristic may be achieved the light guide being provided with a high attenuation in a region around the optical transmitter, and with a low attenuation within the regions more remote from the optical transmitter. This results in a substantially constant signal amplitude and therefore also substantially constant transmission characteristics along the entire path along the light guide.

In an arrangement according to the invention, an encoder is provided between a data source and an optical transmitter for converting the digital coding of a data stream from a data source so that the data can be transmitted along the optical path with a minimum of errors or faults. Accordingly, the encoder may also be incorporated in the data source.

Another advantageous embodiment of the invention provides for a decoder for converting the coding of the encoder to be provided between an optical receiver and a data sink for decoding the encoded signals of the encoder.

Furthermore, advantageously the encoder is designed for converting the spectral characteristics of the data stream so that the power in predetermined spectral ranges can be optionally increased or reduced.

Another advantageous embodiment of the invention provides for the encoding function of the encoder to be dynamically adjustable, and preferably to be set in dependence upon the position of a coupler or the transmission characteristics of the optical path. With this, optimization of the transmission characteristics in dependence upon position is possible.

In another advantageous embodiment of the invention an encoding of the signals is effected so that EMC characteristics are improved, and that, in particular, current standards are complied with. For this, the encoding should lead to a broadening of the signal spectrum. With this, the (radiated) high frequency energy is contained within a greater spectral range at lower spectral power density. An encoding of this kind is of importance not only with wanted signals, but also with interval signals, because here particularly a constant pattern is frequently sent in the form of null or zero data. This embodiment of the invention is important, because frequently optical transmitters having high-power driver stages and correspondingly high electrical signal levels can cause interference.

In another arrangement in accordance with the invention, light is coupled into the light guide so that it propagates in at least two separate directions. Furthermore, at least one coupler is provided to receive light from at least two separate paths. A summation of the optical signals is performed in the coupler or in the receiver. The arrangement is now chosen so that the sum of the light signals is approximately independent from the movement between the light guide and the coupler. With this, a constant optical signal level is always available at the receiver. With this device a receiver of low optical dynamics may be used.

In another arrangement in accordance with the invention, at least one light guide is designed to be optionally a light-guiding fiber that is optionally doped with a fluorescent dye, a light-guiding shaped body, or a light-guiding liquid; and manufacture of the light guide is effected preferably by casting, hot stamping, drawing with a mold flattened on at least one side, or etching of a round fiber.

Another arrangement in accordance with the invention comprises at least one light guide that is a gradient-index fiber having a suitably conformed variation of index on one side. Here the variation of the index gradient is preferably flattened, so that an optical plane for coupling out light with a coupler results.

Another embodiment of the invention provides a plurality of optical transmitters which communicate with a plurality of optical receivers via preferably one light guide and also at least one coupler. An assignment between optical transmitters and optical receivers is effected through a selection of segments of the light guide, a selection of wavelength, a selection of polarization, or a selection of direction. For this, it is special advantage for one coupler to be already designed to be wavelength-selective or polarization-selective. Of course, communication is possible along arbitrary directions, i.e. from one light guide to a coupler, from one coupler to a light guide, or also from a first coupler via a light guide to a second coupler.

Another device in accordance with the invention provides a light guide as an active optical element, in particular as an optical amplifier. Thus, a light guide may be designed to be, for example, an erbium-doped fiber amplifier (EDFA), or a laser. Similarly, a coupler or a light guide connected to this coupler may be designed to be an active optical element. By means of a design of this kind, an amplification may be achieved with appropriately high signal-to-noise ratios already within optical components.

In a special embodiment, a wavelength conversion which is controlled from outside can be achieved. Thus, for example, a light guide may be supplied with a pumping light in one direction, whilst light for exciting an emission is fed-in from outside via a coupler. Similarly, a coupler could be supplied with pumping light, whilst excitation for emission is effected through a light guide.

A computer tomograph in accordance with the invention comprises at least one device in accordance with the above descriptions.

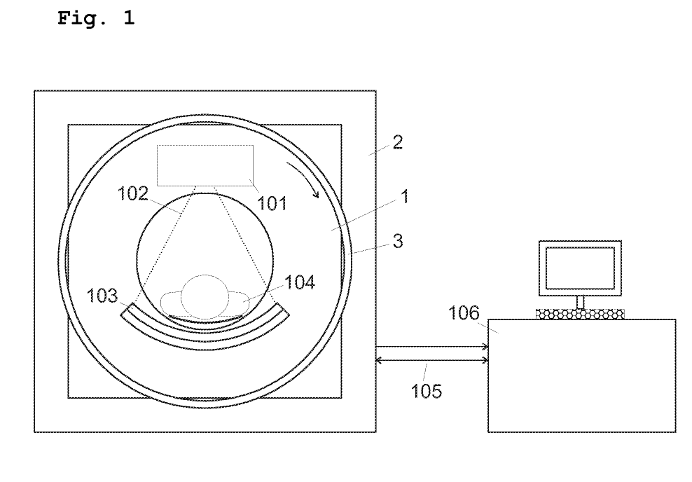

FIG. 1 shows an example of a device according to the invention. A computer tomograph (CT scanner) consists of two main mechanical components. A stationary part 2, in which a rotating part 1 rotates, serves as a base and a support of the entire instrument. A patient 104 is positioned on a rest within an opening of the rotating part. An X-ray tube 101 and, opposite to it, a detector 103 are disposed for scanning the patient by means of X-rays 102. The X-ray tube 101 and the detector 103 are disposed to be rotatable on the rotating part 1. A rotary joint 3 serves as an electrical connection between the rotating part 1 and the stationary part 2.

With this, high electrical power for feeding the X-ray tube 101 is transmitted in the direction of the rotating part 1, and simultaneously video data are transmitted in the opposite direction. A communication of control information in both directions is provided in parallel to this. An evaluation and control unit 106 serves for operation of the computer tomograph, and also for displaying produced images. Communication with the computer tomograph is effected via a bidirectional link 105.

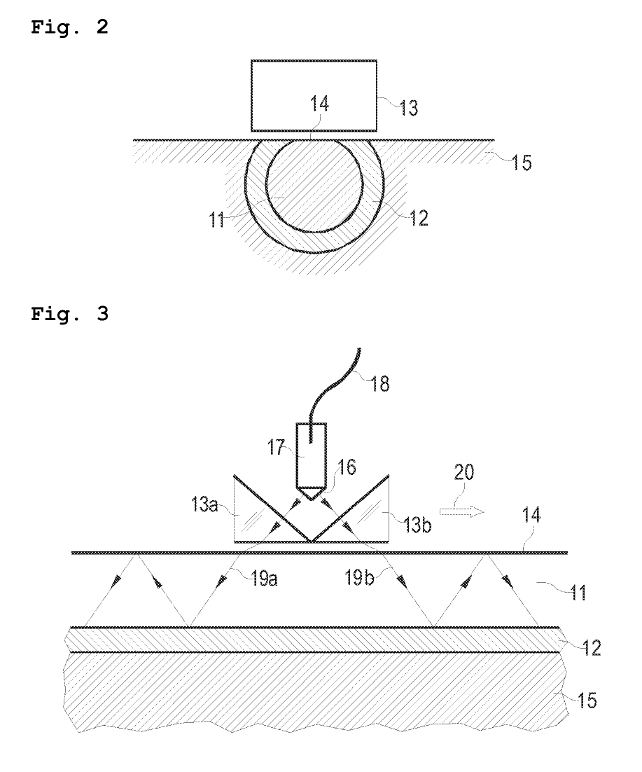

FIG. 2 illustrates in detail a device in accordance with the invention. A light guide consisting of a core 11 and a sheath 12 is embedded in a support material 15. The surface of the light guide together with the support material is ground at a ground face 14 so that a part of the core is exposed. A prism 13 is mounted above the exposed ground face for coupling signals in or out. By means of the extent of the ground face on the light guide, the size of the exposed core surface and therewith the effectiveness of coupling can be predetermined. A small coupling face exhibits low coupling with the prism, but results in less losses during signal guidance in the light guide. Conversely, a large coupling face leads to an increased coupling, but also to increased losses in the light guide. Thus a suitable coupling face must be selected in dependence upon the purpose of a transmission and the length of the light guide. An example of a ground configuration on a surface of a light guide is shown, because this is easily achieved during fabrication. Of course, other measures, such as for example a fabrication of a light guide that is partially sheathed from the start, are conceivable. The support material 15 is not indispensable, it merely facilitates fabrication and is useful in practice for supporting the light guide. Of course, instead of a round light guide, light guides of other configurations, such as for example plane light guides, may be used.

FIG. 3 illustrates another device in accordance with the invention comprising two symmetrically disposed prisms for coupling in signals in two directions. For this, light is supplied by means of a light-guiding fiber 18 and a collimator 17 to a beam-splitting prism 16. This splits the light beam into a first partial beam 19a and a second partial beam 19b. The first partial beam is coupled into a core 11 of the light guide in a first direction of propagation by means of a first prism 13a. The second partial beam is coupled into the core of the light guide in a second direction of propagation by means of a second prism 13b. A directional arrow 20 indicates an example of a movement of the entire coupling-in assembly comprising the prisms 13a, 13b, the beam-splitting prism 16, the collimator 17 and the fiber 18. For the sake of simplicity and clarity, this illustration was restricted to a coupling-in into a light guide by means of the prisms 13a, 13b. Similarly, of course, a coupling-out of signals or a bidirectional signal transmission is possible.

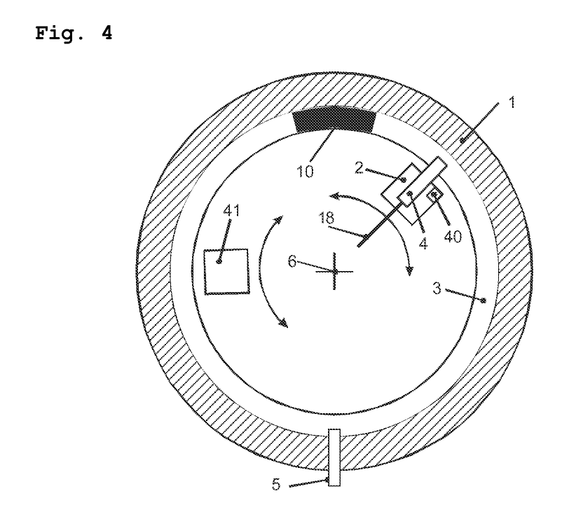

FIG. 4 schematically shows a section of an example of an embodiment of a device in accordance with the invention. In this, both the first unit 1 and the second unit 2 are shown as disks with central bores, supported to be rotatable about a rotation axis 6. Here the light guide 3 is disposed on a circular track, as is the case with rotating data transmission devices and in particular with rotary joints for computer tomographs. It extends around the entire circumference of the first unit. A light coupler 4 is in engagement with this light guide that is disposed on the second unit. This light coupler taps off the light guided in the light guide and passes it on, for example with a light-guiding fiber 18. Light from an optical transmitter 5 is fed at the same phase, referred to a modulation signal, into the light guide 3 in two opposite directions. The site of feeding-in is preferably opposite to that of the absorber, so that the transit times along both directions are equal. The light is tapped off by means of a light coupler 4 that is supported along a track of the light guide 3 to be rotatable about a rotation axis 6 and supplies the tapped-off light to an optical receiver. For the sake of simplicity the optical receiver has not been shown. As an example, a cleaning unit 40 is incorporated in the second unit 2. It runs along the light 3 together with this second unit to appropriately clean the light guide. Furthermore, a independent cleaning unit 41 is shown that can be moved independently from the second light coupler.

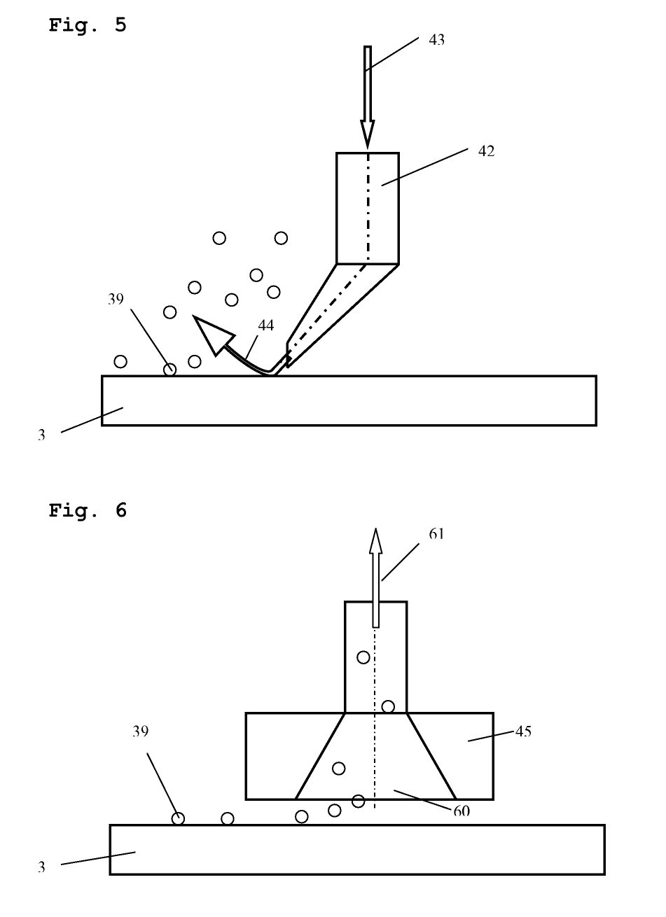

FIG. 5 illustrates a cleaning unit in the form of an appliance for blowing away particles of dust and contamination. An air current 43 from a pressurized air source is blown along the direction of the light guide 3 by means of a nozzle 42. An air current 44 issuing from the nozzle causes a swirl of raised dust particles 39 and blows them away from the light guide 3.

FIG. 6 shows a cleaning unit in the form of a suction appliance. A nozzle block 45 configured as a nozzle comprises a suction opening 60 through which air is sucked-in from the outside. An air stream 61 entrains the dust particles 39 and thus removes them from the surface of the light guide 3.

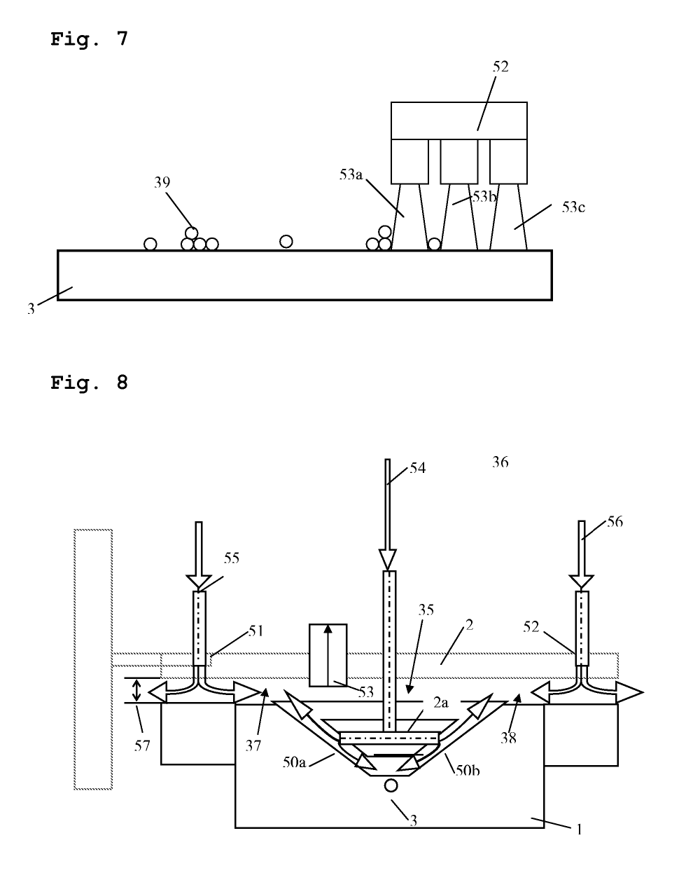

FIG. 7 shows a cleaning unit in the form of a brush unit. A brush holder 52 serves to accommodate brushes 53a, 53b, 53c. The brushes are moved along the light guide 3 and thus sweep away particles of contamination deposited on the surface.

FIG. 8 shows a device in accordance with the invention using seal air as a sealing means. In this illustration, a sliding body 2a connected to the second unit 2 is provided for accommodating the light coupler 4. This sliding body 2a is connected to the second unit 2 so that it performs the same movement along a longitudinal direction of the light guide 3, but effects a stabilization along one or two axes perpendicular thereto, so that an exact alignment of the light coupler 4 on the second unit with respect to the light guide 3 is always ensured. An especially precise support of this sliding body 2a relative to the first unit 1, with low friction at the same time, can be achieved with an air bearing. An air bearing of this kind is illustrated as an especially preferred example for describing the embodiments of the invention. Of course, any other kind of bearing means is possible, such as for example a sliding bearing or a rolling bearing. As an example of an air bearing, two nozzles 50a, 50b are illustrated, from which a supplied air stream 54 is emitted from a not shown pressurized air source in the direction of the first unit 1, in order to build up an air film between the sliding body 2a and the first unit 1. The air introduced through the nozzles flows away laterally between the sliding body 2a and the first unit 1. It can escape from the hollow space shown in the drawing between the components of the first unit 1 and the second unit 2 through a vent valve 53.

For sealing by means of seal air, at least one seal air nozzle 51 is provided for emitting a seal air stream 55 into the space between the first unit 1 and the second unit 2 in such manner that it escapes to the outside from the gap between the two units and thus prevents an entry of particles of dust and other contamination into the gap between the two units. For sealing the second side, a second seal air nozzle 52, fed by a seal air stream 56, has been drawn. In order achieve an optimal sealing performance, the gap 57 between the first unit 1 and the second unit 2 can be optimized. Particularly expedient is a gap of an order of magnitude of 0.03 millimeters to 0.1 millimeters, a pressure of 0.2 bar to 0.5 bar in excess of the ambient having proved to be of advantage. The same applies to the gap 58. The exact number of gaps is of no consequence to the subject matter of the invention, because this is usually a question of definition. Thus, for example, the two gaps 57 and 58 may also be regarded as being one single gap between the two units. Essential to the invention is that at least one gap is present between the two units.

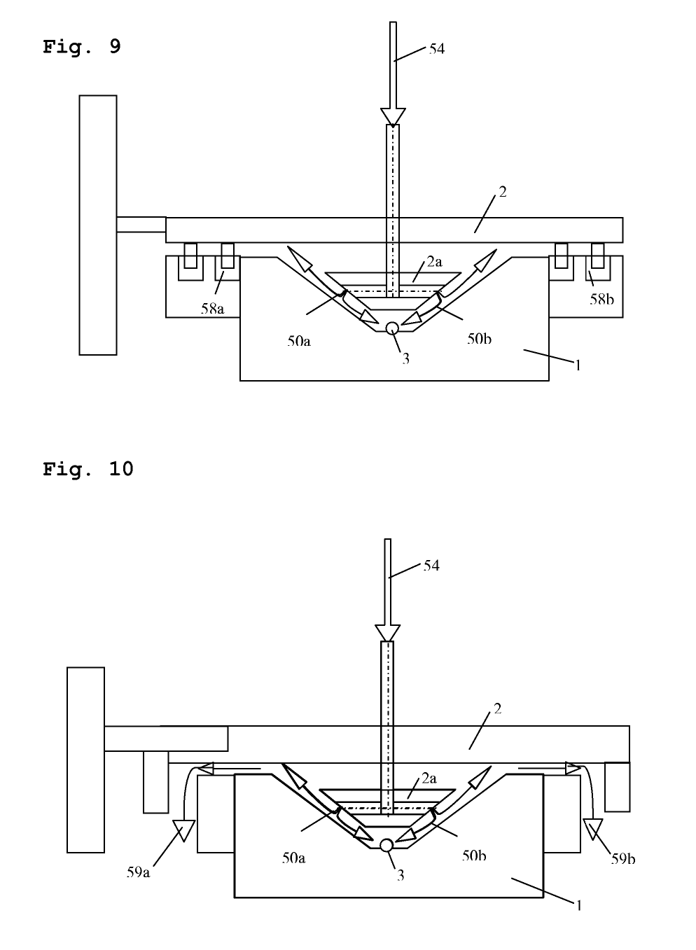

FIG. 9 shows a system according to the invention using a labyrinth sealing means. With this, an entry of dust and other foreign bodies into a region sensitive to contamination surrounding the light guide 3 is rendered difficult by a labyrinth. This labyrinth is preferably configured by the design of an interlocking structure of grooves or ribs between the first unit 1 and the second unit 2. In the particular case of embodiment using an air bearing means, as illustrated here, the supplied air stream 54 blown into the hollow space escapes to the outside through the labyrinth after emerging from the bearing means and obstructs any entry of contaminating matter. However, a labyrinth sealing means of this kind is capable of operating even without the air stream.

FIG. 10 shows a system according to the invention using excess pressure as a sealing means. In a similar manner as in the previous example, an aim is to maintain a continuous air stream 59a or 59b towards the outside, however, with a substantially larger amount of air. As distinct from the case of the labyrinth sealing means, the mechanical design here is substantially more simple, however, without the air stream only a very small sealing action can be expected. However, in many cases of application this need not be regarded as being particularly critical, because in a non-operating condition of a system, the amount of dust whirled upwards from the outside, and with it a risk of contamination, is usually substantially less. An air supply can be effected optionally from the supply to the air bearing means, or by means of additional inlet openings. Preferably a plurality of inlet openings are provided by being distributed along the circumference of the arrangement.

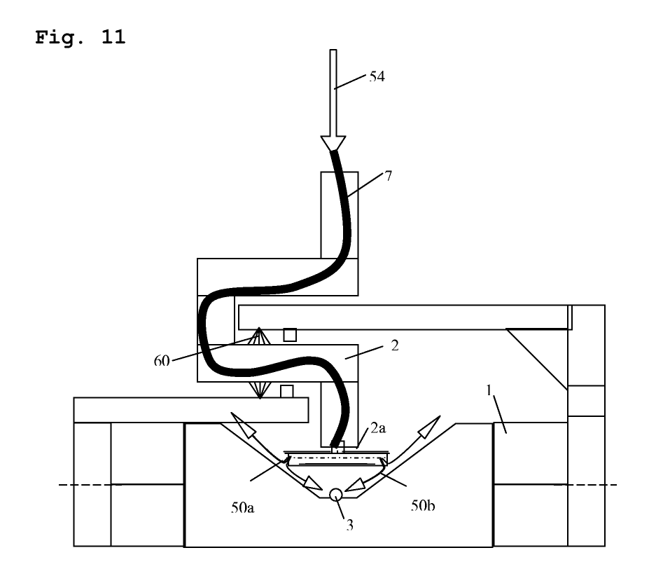

FIG. 11 shows a system accordance with the invention using a brush sealing means. In this, brushes 60 are provided for preventing an entry of dust and contamination into the space between the first unit 1 and the second unit 2. In an advantageous manner, additional barriers or labyrinths may be provided for improving the sealing action. In this example of embodiment a fixed cover 1 a is provided on the first unit 1, so that only a relatively small region is left for the second unit 2 to allow a passage for a light-guiding fiber 7, and also for the supplied air stream 54 which is needed in this example.

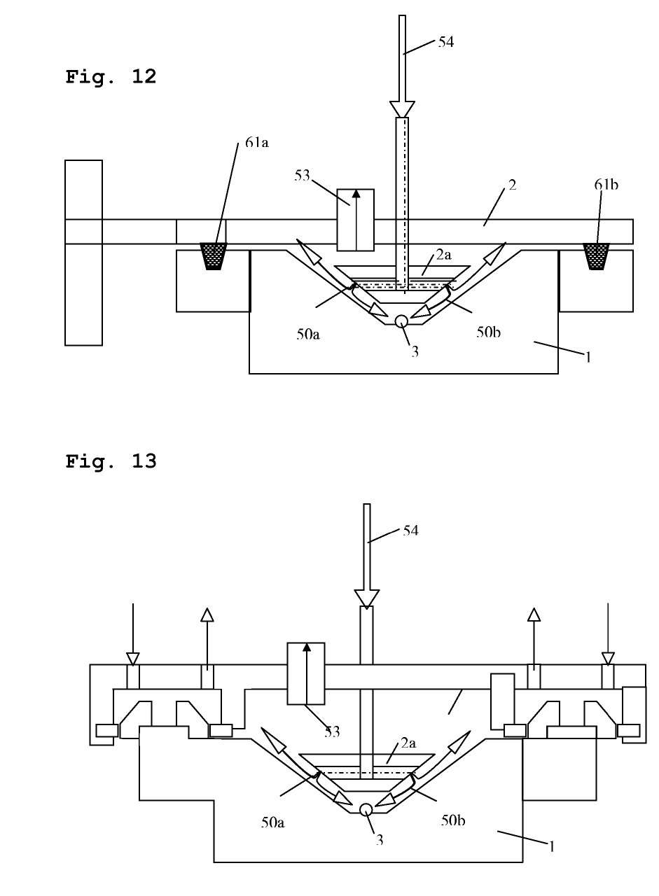

FIG. 12 shows a system in accordance with the invention using a felt sealing means. A sealing means of this kind may be configured similarly to the above-described brush sealing means. Here, once again for example, the plane arrangement of the first unit 1 and the second unit 2 is illustrated. Here, the internal excess pressure may also be used to back up the felt sealing means.

FIG. 13 shows a system according to the invention using a sliding-ring sealing means. Because of the symmetrical construction of the system shown here, reference will be made only to the sliding-ring sealing means shown on the left-hand side of the illustration. Basically, a simple sliding-ring sealing means having a sliding ring 62 and also a counter-ring 63 would already effect a sealing of the inner space. To improve the sealing action, a second sliding ring 64 with an associated counter ring 65 is also provided. Furthermore, seal air or another seal means, such as for example a liquid, is introduced into the intermediate space defined by the two sliding rings and their counter-rings through a seal air inlet 66, and is discharged through a seal air outlet 67.

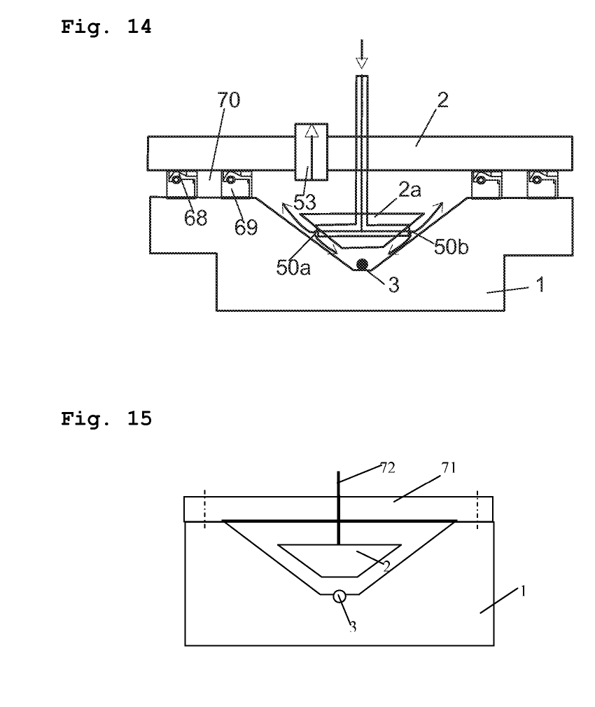

FIG. 14 shows a system according to the invention using a rotary-shaft sealing means. Here, rotary-shaft sealing rings 68, 69 are provided for sealing the inner space. For example, a lubricant can be introduced into the intermediate space 70 between the rotary-shaft sealing rings. It may be subjected to impingement by seal air in a similar way to that previously illustrated.

FIG. 15 shows a system according to the invention using a static sealing means. Here, as distinct from the previously described sealing systems, the space above the light guide 3 is completely sealed statically. For this, a light-transmitting cover 71, such as for example a glass plate or a polymethylmethacrylate plate may be mounted above the light guide. Light is preferably coupled through the light-transmitting cover 71 in the form of a light beam 72 that can be freely positioned. A sliding body 2a assigned to the second unit 2 and containing the optical elements needed for coupling with the light guide 3 may be mechanically coupled with the second unit 2, for example with magnetic take-up means.

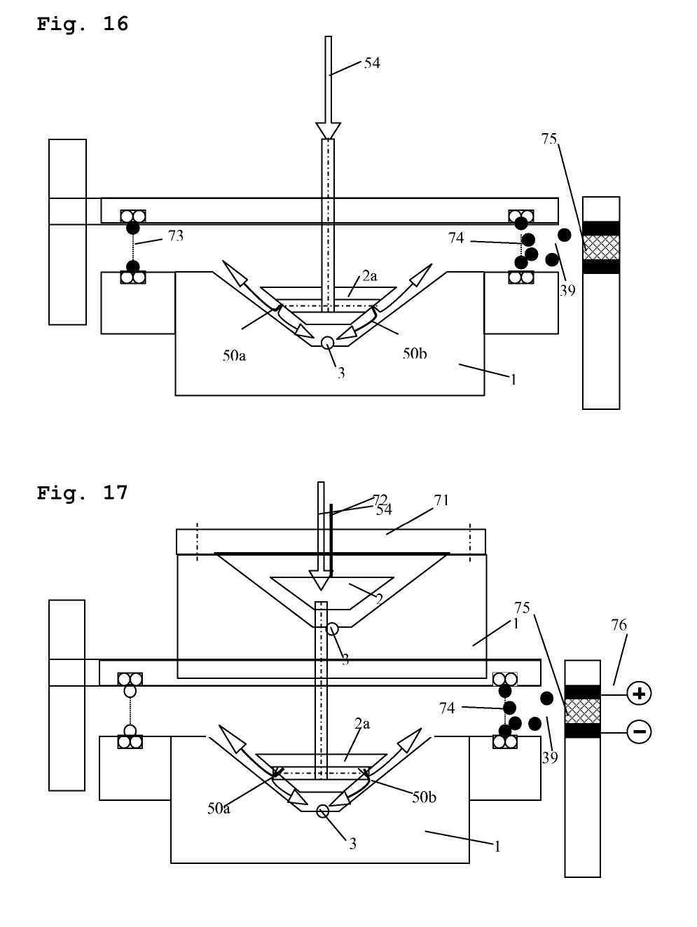

FIG. 16 shows a system according to the invention using a mechanical filter. Here a mechanical filter 73 or 74 is provided in order to prevent an entry of particles of dust or contamination particles into the intermediate space between the first unit 1 and the second unit 2. A gauze, for example, may be used as a filter material. By way of supplementation, a further filter 75 having a larger surface, for example an expanding-bellows type filter, may be employed. With this, rapid clogging of the filter may be prevented or delayed. Additional support for the filter action, or cleaning of the filter, can be effected by means of the supplied air stream 54 from the inside.

FIG. 17 shows a system according to the invention using an electrostatic filter. This is basically built up similarly to the previously described system with the mechanical filter. However, here an electrostatic filter is optionally employed instead of the mechanical filter 73, 74 or the gauze, or also instead of the additional filter 75. The power supply for this electrostatic filter is effected via high-tension terminals 76.

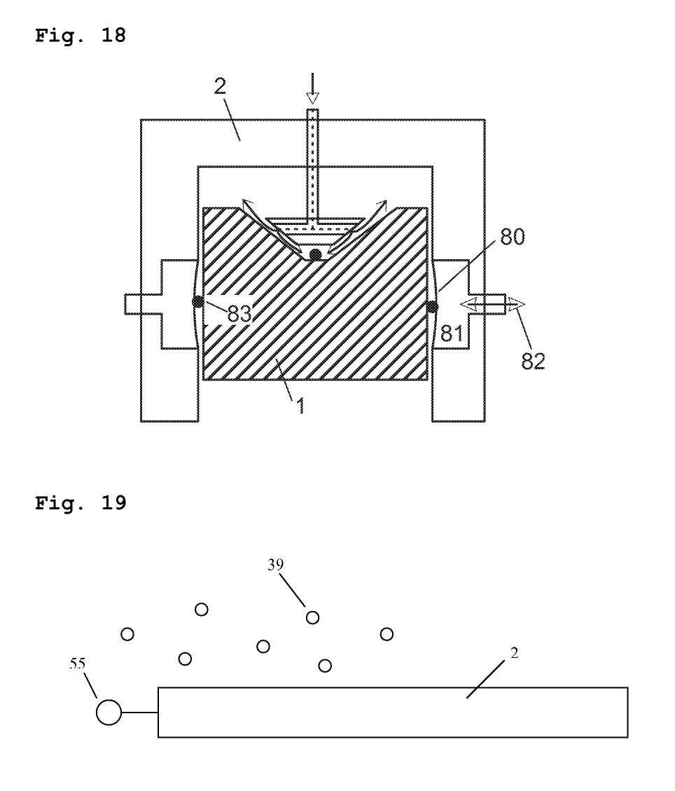

FIG. 18 shows an arrangement using a diaphragm sealing means. In this, a sealing diaphragm 80 is provided and disposed in front of a hollow space 31. The position of the sealing diaphragm can now be changed by means of vacuum or pressurized air 82. In the shown illustration it may be urged against the seal 83 of the first unit by being impacted by pressurized air, and lifted off by the action of vacuum. The gap clearance 84 indicates the lift of the sealing diaphragm. In the illustrated embodiment the diaphragm is so dimensioned that in a rest condition when subjected to no load it just rests against the sealing ring. With this, a certain minimum sealing action is ensured, even in the rest condition. To increase the sealing action, the hollow space or the reverse side of the diaphragm may now the subjected to impingement by excess pressure. During operation, the air is removed from the hollow space by vacuum, so that the sealing diaphragm is lifted off from the seal and operation is possible with a minimum of friction.

Of course, the various embodiments of the invention as described here may be combined with each other in order to achieve more tight sealing, or an improved filtering, against an entry of particles of contamination and dust FIG. 19 shows another kind of electrostatic cleaning of the surface, in particular that of the second unit. For this it is subjected to high voltage with a static voltage supply 55, so that charged particles of dust and contamination 39 are repelled. An additional surface of opposite polarity may be provided for now attracting and retaining these particles. For this, the surface may be provided with a coating, preferably of a polymer having high adhesive properties.

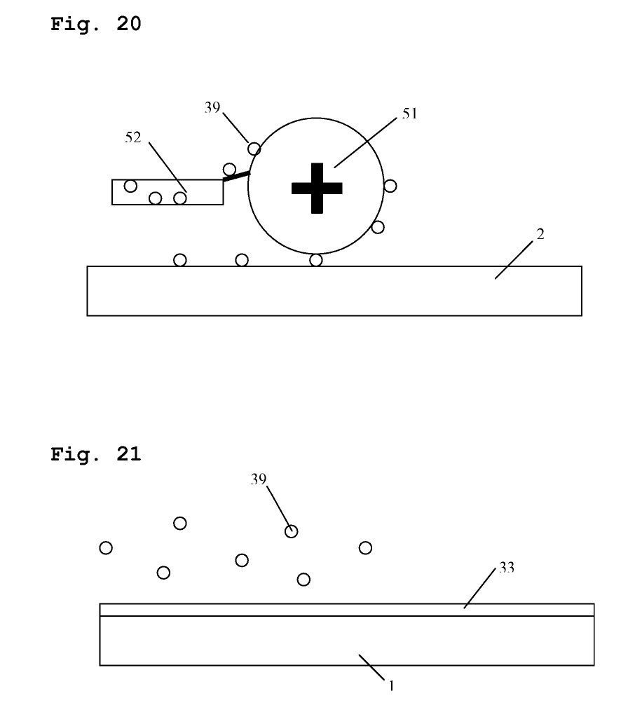

FIG. 20 shows a system according to the invention using a roller for taking-up charged particles of dust and contamination. For this, a roller 51 that is charged, for example by means of a voltage supply, is moved close to and along the surface to be cleaned, preferably that of the second unit. This now takes-up charged particles of dust and contamination. In order for a non-contaminated surface of the roller to be always available, the roller is moved along whilst in rotary motion. In the present example, the direction of rotation is counter-clockwise. Furthermore, a collector 52 is provided for stripping particles of dust and contamination from the roller. The surface of the roller may be variously configured. Thus, the roller may be provided with a continuous conducting surface which is fed in its entirety from a high voltage supply. It also may be configured similarly to known photoconductive drums in photocopying apparatus or laser printers, the charging of the surface being effected from a corona electrode disposed in the vicinity of the surface.

Furthermore, FIG. 21 illustrates a combined micro/nano-coating for preventing contamination from depositing on the surface, by means of an effect as known from a lotus blossom. A structure of this kind can be mounted optionally on the first unit 1, or the second unit 2, or on other parts such as the light guide. For this, preferably a microstructure having elevated portions of sizes in a micrometer range is combined with an overlying nanostructure having elevated portions of sizes in a nanometer range. A surface coated in this manner can now be configured, for example, so that contamination can be completely blown away from the critical regions of the surface (optical components). Similarly, the contamination may be specifically directed into a collecting container, or into a collecting filter.

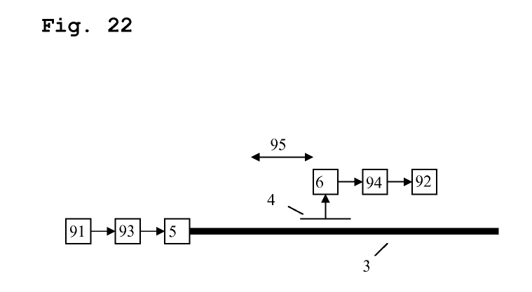

FIG. 22 illustrates an example of a device with a controller for conforming the data rate to the conditions of the transmission path. A data source 91 supplies electrical data via the controller 93 to the optical transmitter 5. The light is transmitted via a light guide 3 and tapped off by a coupler 4 in dependence upon position. The light of the coupler is converted back to electrical signals by means of an optical receiver 6 and transmitted to the data sink 92 via an evaluation circuit 94.

1.-96. (canceled)

97. A device for transmitting optical signals between at least two units that are movable relative to each other along a track of movement, in particular between rotating parts of a computer tomograph, comprising:
a first unit having a light guide disposed along the track of movement, a core of the light guide being only partly enclosed by a sheath along an axis of the core;
a second unit having a coupler that is movable along the light guide for coupling optical signals into or out of the light guide, the coupler comprising at least one of a prism and another coupling element for coupling evanescent fields;
at least one optical transmitter as a light source, and at least one optical receiver as a light sink, the optical transmitters and optical receivers being optionally assigned to the first unit and the second unit;
at least one optical path between one optical transmitter and one optical receiver, passing through the light guide and the coupler;
wherein at least one optical transmitter comprises means for electric control of emitted optical power; and
wherein a control unit is provided for controlling optical power of the optical transmitter so that optical power at an input of an optical receiver of an assigned optical path is in a predetermined range of tolerance.

98. A device for transmitting optical signals between at least two units that are movable relative to each other along a track of movement, in particular between rotating parts of a computer tomograph, comprising:
a first unit having a light guide disposed along the track of movement, a core of the light guide being only partly enclosed by a sheath along an axis of the core;
a second unit having a coupler that is movable along the light guide for coupling optical signals into or out of the light guide, the coupler comprising at least one of a prism and another coupling element for coupling evanescent fields;
at least one optical transmitter as a light source, and at least one optical receiver as a light sink, the optical transmitters and optical receivers being optionally assigned to the first unit and the second unit;
at least one optical path between one optical transmitter and one optical receiver, passing through the light guide and the coupler; and
wherein a diagnostic unit is assigned to at least one of the two units that are movable relative to each other for determining an operational condition of at least one of the movable units and signaling the operational condition to a central control unit.

99. The device according to claim 98, wherein at least one diagnostic unit is designed for quantitative indication of operating parameters, in particular critical parameters such as signal amplitude, signal-to-noise ratio, signal characteristics, or eye diagram.

100. A device for transmitting optical signals between at least two units that are movable relative to each other along a track of movement, in particular between rotating parts of a computer tomograph, comprising:
a first unit having a light guide disposed along the track of movement, a core of the light guide being only partly enclosed by a sheath along an axis of the core;
a second unit having a coupler that is movable along the light guide for coupling optical signals into or out of the light guide, the coupler comprising at least one of a prism and another coupling element for coupling evanescent fields;
at least one optical transmitter as a light source, and at least one optical receiver as a light sink, the optical transmitters and optical receivers being optionally assigned to the first unit and the second unit;
at least one optical path between one optical transmitter and one optical receiver, passing through the light guide and the coupler; and
wherein a preferably controllable absorber is provided on at least one site along the optical path through the light guide.

101. The device according to claim 100, wherein the light guide is divided into a plurality of segments, each segment being supplied with light by one of the light couplers, and wherein lengths of the segments, directions of propagation of light along the segments, and any supply leads to the segments are designed so that at boundaries between any two segments in which a same light signal is transmitted, a transit time or phase of a modulation signal has only slight differences which are small in comparison with a length of a period of the modulation signal.

102. The device according to claim 101, wherein groups which each consist of two adjacent segments are provided, the two adjacent segments having the same transit times and opposite directions of propagation of the light.

103. The device according to claim 100, wherein at least one preferably controllable absorber is disposed on a site opposite to that of the first light coupler relative to a rotation axis, whereby the light guide is divided into at least two segments.

104. The device according to claim 100, wherein at least one preferably controllable absorber is disposed along the light guide, and only a range of the absorber needed for absorption is activated by an activation signal, so that it is preferably synchronously movable with a second light coupler most preferably to a site located opposite to the second light coupler.

105. The device according to claim 100, wherein a plurality of preferably controllable absorbers are provided which have variable sites and/or are activated and deactivated at predetermined sites, so that they divide the light guide into a plurality of segments that are suitable for simultaneous transmission of different signals.

106. The device according to claim 100, wherein at least one controllable absorber is synchronously movable together with a second light coupler, preferably to a site located opposite to the second light coupler.

107. The device according to claim 100, wherein at least one first light coupler is provided with the light guide for coupling light into or out of the light guide in respectively a first direction and an opposite second direction of the light guide, and wherein at least one controllable second absorber is provided that comprises at least two segments which are adapted to be controlled alternately, and are controlled so that at any instant of time at least one second light coupler receives at least one signal from the first or the second direction.

108. The device according to claim 100, wherein a means for controlling a controllable absorber is provided, so that an attenuation of an optical signal between a first light coupler and a second light coupler is approximately constant.

109. The device according to claim 100, wherein at least one preferably controllable absorber is designed to be wavelength-selective and/or polarization-selective.

110. The device according to claim 100, wherein at least one controllable absorber comprises reversible scattering centers, a formation of which can be controlled by a signal or a supply of energy.

111. The device according to claim 100, wherein at least one controllable absorber comprises at least one of: (i) a liquid crystal element; (ii) photonic crystals; (iii) a controllable deflecting element for deflecting a settable proportion of light carried in the light guide out of the light guide, and/or onto an absorber; (iv) a multiple layer system capable of interference; and/or (v) an optical grating.

112. The device according to claim 100, wherein at least one controllable absorber is adapted to be inserted into the optical path by means of an optical switch.

113. The device according to claim 100, wherein at least one controllable absorber is adapted to be controlled mechanically, and preferably actuated by an electromotive, electromagnetic, piezoelectric or pneumatic element.

114. The device according to claim 100, wherein at least one controllable absorber comprises a mechanical element that is adapted to be moved into or out of a path of rays of the light guide.

115. The device according to claim 100, wherein at least one preferably controllable absorber is adapted to simultaneously receive optical signals and at least to evaluate a signal amplitude thereof.

116. The device according to claim 101, wherein at least one second light coupler is provided for coupling light from a light guide and relaying the light to an absorber.

117. A device for transmitting optical signals between at least two units that are movable relative to each other along a track of movement, in particular between rotating parts of a computer tomograph, comprising:
a first unit having a light guide disposed along the track of movement, a core of the light guide being only partly enclosed by a sheath along an axis of the core;
a second unit having a coupler that is movable along the light guide for coupling optical signals into or out of the light guide, the coupler comprising at least one of a prism and another coupling element for coupling evanescent fields;
at least one optical transmitter as a light source, and at least one optical receiver as a light sink, the optical transmitters and optical receivers being optionally assigned to the first unit and the second unit;
at least one optical path between one optical transmitter and one optical receiver, passing through the light guide and the coupler; and
wherein a control unit is provided for optionally controlling at least one controllable absorber, an optical transmitter, a distance between a coupler and a light guide or another optical component in the optical path, so that an optical or electrical signal amplitude at a coupler, or preferably at an optical receiver is maintained at a constant value.

118. A device for transmitting optical signals between at least two units that are movable relative to each other along a track of movement, in particular between rotating parts of a computer tomograph, comprising:
a first unit having a light guide disposed along the track of movement, a core of the light guide being only partly enclosed by a sheath along an axis of the core;
a second unit having a coupler that is movable along the light guide for coupling optical signals into or out of the light guide, the coupler comprising at least one of a prism and another coupling element for coupling evanescent fields;
at least one optical transmitter as a light source, and at least one optical receiver as a light sink, the optical transmitters and optical receivers being optionally assigned to the first unit and the second unit;
at least one optical path between one optical transmitter and one optical receiver, passing through the light guide and the coupler; and
wherein at least one timing recovery circuit is provided for recovering optionally a timing or data of electrical signals supplied to an optical transmitter, and/or of electrical signals supplied by an optical receiver.

119. A device for transmitting optical signals between at least two units that are movable relative to each other along a track of movement, in particular between rotating parts of a computer tomograph, comprising:
a first unit having a light guide disposed along the track of movement, a core of the light guide being only partly enclosed by a sheath along an axis of the core;
a second unit having a coupler that is movable along the light guide for coupling optical signals into or out of the light guide, the coupler comprising at least one of a prism and another coupling element for coupling evanescent fields;
at least one optical transmitter as a light source, and at least one optical receiver as a light sink, the optical transmitters and optical receivers being optionally assigned to the first unit and the second unit;
at least one optical path between one optical transmitter and one optical receiver, passing through the light guide and the coupler;
wherein a data source for generating a serial data stream is provided for controlling at least one optical transmitter;
wherein a data sink is provided for further processing of signals of at least one optical receiver; and
wherein a controller for controlling the data stream is provided for optionally signalling to the data source a predetermined data rate or package size by means of a preset value, or is disposed optionally between the data source and the optical transmitter, and converts data of the data source in accordance with a preset value into a predetermined data rate or a package of a predetermined package size.

120. The device according to claim 119, wherein the controller comprises means for storing data, and also for issuing data at different data rates to the optical transmitter.

121. The device according to claim 119, wherein the preset value is set by the controller in accordance with instant transmission characteristics of a data path between optical transmitter and optical receiver, or with another measured parameter.

122. The device according to claim 119, wherein an evaluation circuit is provided between an optical transmitter and an optical receiver, wherein the evaluation circuit comprises means for signaling erroneously transmitted data to the controller by means of a separate transmission channel, and wherein the controller is adapted to repeat a transmission of erroneously received data packages upon request by the evaluation circuit.

123. The device according to claim 119, wherein a microcontroller is provided for control and diagnosis of the device and/or the device is self-learning and dynamically adapts to prevailing operational conditions.

124. A device for transmitting optical signals between at least two units that are movable relative to each other along a track of movement, in particular between rotating parts of a computer tomograph, comprising:
a first unit having a light guide disposed along the track of movement, a core of the light guide being only partly enclosed by a sheath along an axis of the core;
a second unit having a coupler that is movable along the light guide for coupling optical signals into or out of the light guide, the coupler comprising at least one of a prism and another coupling element for coupling evanescent fields;
at least one optical transmitter as a light source, and at least one optical receiver as a light sink, the optical transmitters and optical receivers being optionally assigned to the first unit and the second unit;
at least one optical path between one optical transmitter and one optical receiver, passing through the light guide and the coupler; and
wherein an encoder is provided between a data source and an optical transmitter for converting a digital coding of a data stream from a data source, so that data can be transmitted via the optical path with a minimum of errors and/or that electromagnetic emissions from electrical or electronic components are reduced.

125. The device according to claim 124, wherein a decoder for converting a coding of the encoder is provided between an optical receiver and a data sink.

126. The device according to claim 124, wherein the encoder is designed for converting spectral characteristics of a data stream, so that in predetermined spectral regions a power is optionally increased or decreased.

127. The device according to claim 124, wherein an encoding function of the encoder is dynamically adjustable, and is set preferably in dependence upon a location of a coupler or transmission characteristics of the optical path.

128. A device for transmitting optical signals between at least two units that are movable relative to each other along a track of movement, in particular between rotating parts of a computer tomograph, comprising:
a first unit having a light guide disposed along the track of movement, a core of the light guide being only partly enclosed by a sheath along an axis of the core;
a second unit having a coupler that is movable along the light guide for coupling optical signals into or out of the light guide, the coupler comprising at least one of a prism and another coupling element for coupling evanescent fields;
at least one optical transmitter as a light source, and at least one optical receiver as a light sink, the optical transmitters and optical receivers being optionally assigned to the first unit and the second unit;
at least one optical path between one optical transmitter and one optical receiver, passing through the light guide and the coupler;
wherein a plurality of optical transmitters communicate with a plurality of optical receivers via preferably one light guide and also at least one coupler; and
wherein an assignment between optical transmitters and optical receivers is effected through a selection of segments of the light guide, a selection of wavelength, a selection of polarization, or a selection of direction.

129. A device for transmitting optical signals between at least two units that are movable relative to each other along a track of movement, in particular between rotating parts of a computer tomograph, comprising:
a first unit having a light guide disposed along the track of movement, a core of the light guide being only partly enclosed by a sheath along an axis of the core;
a second unit having a coupler that is movable along the light guide for coupling optical signals into or out of the light guide, the coupler comprising at least one of a prism and another coupling element for coupling evanescent fields;
at least one optical transmitter as a light source, and at least one optical receiver as a light sink, the optical transmitters and optical receivers being optionally assigned to the first unit and the second unit;
at least one optical path between one optical transmitter and one optical receiver, passing through the light guide and the coupler; and
wherein at least one light guide is designed to be an active optical element, in particular an EDFA or a laser and/or at least one light guide is a gradient-index fiber, preferably having a conformed variation of index on one side.

130. The device according to claim 33, wherein at least one light guide is an active optical element to be supplied with pumped light, and wherein excitement of the light guide to cause emission is controlled by a coupler.
